(19) United States
(12) Patent Application Publication
(10) Pub. No.: US 2015/0346910 A1
(43) Pub. Date: Dec. 3, 2015

(54) OPTICAL IMAGING SYSTEM CAPABLE OF PREVENTING OVEREXPOSURE

(71) Applicant: Wistron Corporation, New Taipei City (TW)

(72) Inventors: Yu-Yen Chen, New Taipei City (TW); Po-Liang Huang, New Taipei City (TW)

(21) Appl. No.: 14/457,121

(22) Filed: Aug. 12, 2014

(30) Foreign Application Priority Data
May 29, 2014 (TW) 103118846

(51) Int. Cl. G06F 3/042

(52) U.S. Cl. CPC G06F 3/0421

(57) ABSTRACT

An optical imaging system capable of preventing overexposure includes a display panel, at least one light source, at least one reflective unit, at least one image capturing module and a control module. The at least one image capturing module is disposed on an outer side of the display panel and is spaced from the at least one reflective unit in a predetermined distance. The at least one reflective unit reflects light reflected from a touch object to the at least one image capturing module, and the at least one image capturing module captures the light reflected from the touch object to generate a corresponding touch signal. The control module is coupled to the at least one image capturing module and for calculating a coordinate value of the touch object on a coordinate detecting area of the display panel according to the touch signal.

### BACKGROUND OF THE INVENTION

1. Field of the Invention

The present invention relates to an optical imaging system, and more specifically, to an optical imaging system capable of preventing overexposure.

2. Description of the Prior Art

In the modern consumer electronic product market, a portable electronic product, such as a personal digital assistant, a smart phone or a mobile phone, is equipped with a touch control device as an interface for data transmission, and those consumer electronic products have become lighter, thinner, shorter, and smaller. A variety of touch control technologies, such as a resistive type, a capacitive type, an ultrasonic type, an infrared type, an optical imaging type and so on, have been developing. Due to consideration for technology level and cost, the above mentioned touch control technologies have been implemented in various fields.

For example, principle of the optical imaging system is to utilize two image capturing modules located at two corners of a display panel for detecting a position of a touch object on the display panel. Then, the location of the touch object on the display panel is calculated by triangulating location. Thus, compared with the conventional resistive type or capacitive type touch device, it has advantages of accuracy, high penetration, good stability, low damage rate, low cost and being capable of multi-touch. However, the conventional optical imaging system has a problem of image overexposure when the touch object is too close to the image capturing module, resulting in inaccuracy in determining the location of the touch object.

Please refer to FIG. 1 to FIG. 3. FIG. 1 is a schematic diagram of the optical imaging system 1 in the prior art. FIG. 2 and FIG. 3 are different relation diagrams of signal intensity and location when the touch object is located at different locations on the optical imaging system 1 in the prior art. The optical imaging system 1 is an interrupting optical imaging system. The optical imaging system 1 includes a display panel 12, two light sources 14, a reflective frame 16 and two image capturing modules 18. Each light source 14 of the optical imaging system 1 emits light to the reflective frame 16. Each image capturing module 18 captures the light reflected from the reflective frame so as to generate an initial signal. As shown in FIG. 2, when a touch object 22 moves within the display panel 12, the light captured by the image capturing module 18 is interrupted so as to generate a corresponding interrupting touch signal with a notched waveform whose signal intensity is less than a threshold, for calculating a coordinate value corresponding to the touch object 22. As shown in FIG. 3, when another touch object 24 is too close to the image capturing module 18, the image capturing module captures a lot of light reflected from the touch object 24. Therefore, a correct interrupting touch signal cannot be generated, that is, signal intensity of a central portion of the notched waveform is not less than the threshold but its ends are less than the threshold. Thus, it makes a mistake in judging as two interrupting areas, due to image overexposure. In order to prevent overexposure, it needs to keep a distance d between the image capturing module 18 and the boundary of an effective touch area of the touch object to avoid that the touch object is too close to the image capturing modules 18. As a result, the size of the optical imaging system would be enlarged, and it causes inconvenience of installation and use and increase in manufacturing cost. It does not fulfill the requirement of the design trends of slimness and light weight of the modern consumer electronic products. Therefore, it is an important issue to design an optical imaging system capable of preventing overexposure and with a small size.

### SUMMARY OF THE INVENTION

The present invention is to provide an optical imaging system capable of preventing overexposure and with a small size to solve the above drawbacks.

According to the disclosure, an optical imaging system includes a display panel, at least one light source, at least one reflective unit, at least one image capturing module and a control module. A coordinate detecting area is formed on the display panel. The at least one light source is disposed on an outer side of the display panel. The at least one light source emits light so as to illuminate a touch object moving within the coordinate detecting area. The at least one reflective unit is disposed on an outside corner of the display panel. The at least one image capturing module is disposed on an outer side of the display panel and spaced from the at least one reflective unit in a predetermined distance. The at least one reflective unit reflects light reflected from the touch object to the at least one image capturing module. Furthermore, the at least one image capturing module captures the light reflected from the at least one reflective unit so as to generate a touch signal corresponding to the touch object. The control module is coupled to the at least one image capturing module. The control module calculates a coordinate value of the touch object on the coordinate detecting area according to the touch signal.

According to the disclosure, the at least one light source, the at least one reflective unit and the at least one image capturing module are disposed on an outer side of the coordinate detecting area.

According to the disclosure, the at least one light source is a laser light emitting diode or an infrared light emitting diode for emitting a collimated light beam, and the at least reflective unit further reflects the collimated light beam emitted from the at least one light source to the touch object.

According to the disclosure, the at least one reflective unit and the at least one image capturing module are spaced from each other in a predetermined distance in a horizontal direction.

According to the disclosure, the optical imaging system includes two image capturing modules and two reflective units. The two reflective units are respectively disposed on two opposite outside corners of the coordinate detecting area. Incident sides of the two image capturing modules face away from each other, and the two image capturing modules are disposed between the two reflective units and for capturing the light reflected from the two reflective units.

According to the disclosure, the at least one image capturing module captures the light reflected from the at least one reflective unit when the touch object moves within the coordinate detecting area so as to generate an interrupting signal corresponding to the touch object, and the control module calculates the coordinate value of the touch object on the coordinate detecting area according to the interrupting signal as a signal intensity of the interrupting signal is less than a threshold.

According to the disclosure, the at least one image capturing module captures the light reflected from the at least one reflective unit when the touch object moves within the coordinate detecting area so as to generate a reflecting signal corresponding to the touch object, and the control module calculates the coordinate value of the touch object on the coordinate detecting area according to the reflecting signal as a reflecting signal intensity is greater than a threshold.

According to the disclosure, the at least one reflective unit is a planar mirror or a convex mirror.

According to the disclosure, the optical imaging system further includes a plurality of positioning units disposed around the coordinate detecting area. The at least one reflective unit reflects light reflected from the plurality of positioning units to the at least one image capturing module, and the control module further calculates the coordinate value of the touch object on the coordinate detecting area according to the light reflected from the touch object and the plurality of positioning units and captured by the at least one image capturing module.

According to the disclosure, the plurality of positioning units is equally spaced around the coordinate detecting area.

The optical image system of the present invention increases an optical path of the reflective light reflected from the touch object in the horizontal direction by means of spaced disposal of the image capturing module and the reflective unit in the horizontal direction so as to prevent image overexposure caused by the close distance between the touch object and the image capturing module, resulting in misjudgment of the location of the touch object on the coordinate detecting area. Besides, the present invention can effectively reduce the dimension of the optical image system and achieve convenient assembly and utilization. Therefore, it fulfills the design trends of slimness and light weight of the modern consumer product. Furthermore, the light source, the reflective unit and the image capturing module can be installed in the same optical machine module so that all components can be rapidly installed on the display module, and the modular optical machine module can be applicable to the various display panels with different sizes so as to save the cost of a manufacturing mold.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an optical imaging system in the prior art.

FIG. 2 and FIG. 3 are different relation diagrams of signal intensity and location when a touch object is at different locations on the optical image system in the prior art.

FIG. 4 is a schematic diagram of an optical imaging system according to a first embodiment of the invention.

FIG. 5 is a structural diagram of a light source and an image capturing module according to the first embodiment of the invention.

FIG. 6 is a schematic diagram of an optical machine module according to the second embodiment of the invention.

FIG. 7 is a schematic diagram of an optical imaging system according to the second embodiment of the invention.

### DETAILED DESCRIPTION

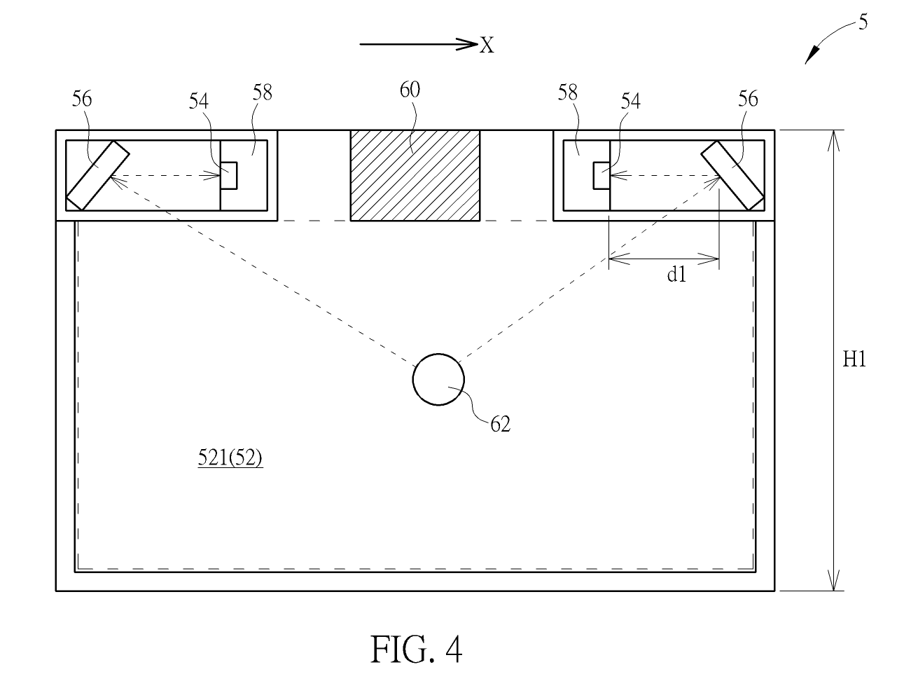

Please refer to FIG. 4. FIG. 4 is a schematic diagram of an optical image systems according to a first embodiment of the invention. The optical image system 5 includes a display panel 52, at least one light source 54, at least one reflective unit 56, at least one image capturing module 58 and a control module 60. The display panel 52 can be a touch panel whereon a coordinate detecting area 521 is formed. The at least one light source 54 is disposed on an outer side of the display panel 52. The at least one light source 54 emits light so as to illuminate a touch object 62 moving within coordinate detecting area 521. In this embodiment, the optical image system 5 can include two light sources 54 which respectively are laser light emitting diodes or infrared light emitting diodes and so on. At least one reflective unit 56 is disposed on an outside corner of the coordinate detecting area 521. The reflective unit 56 can be a planar mirror, and there is an included angle formed between the display panel 52 and a frame of the display panel 52 so that light reflected from the touch object 62 in the coordinate detecting area 521 can be reflected from the reflective unit 56 to the image capturing module 58. For example, the included angle can be 45 degrees. The optical image system 5 can include two reflective units 56, and the two reflective units 56 are respectively disposed on two opposite outside corners of the coordinate detecting area 521.

Furthermore, the image capturing module 58 is disposed on an outer side of the coordinate detecting area 521 and spaced from the corresponding reflective unit 56 in a predetermined distance d1. The reflective unit 56 reflects the light reflected from the touch object 62 to the image capturing module 56, and the image capturing module 56 captures the light reflected from the corresponding reflective unit 56 so as to generate a touch signal corresponding to the touch object 62. The optical image system 5 can include two image capturing modules 58 whose incident sides face away from each other, and the two image capturing modules 58 are disposed between the two reflective units 56. The control module 60 is coupled to the image capturing modules 58. The control module 60 calculates a coordinate value of the touch object 62 on the coordinate detecting area 521 according to the touch signal. In this embodiment, the light source 54, the reflective unit 56 and the image capturing module 58 can be disposed on the same outer side of the display panel 52, but it is not limited to this embodiment. Moreover, the display panel 52, the light source 54, the reflective unit 56, the image capturing module 58 and the control module 60 of the present invention can be integrated in a single display device, such as a monitor or an All In One PC and etc. Alternatively, the light source 54, the reflective unit 56, the image capturing module 58 and the control module 60 can be modularized separately, such as being disposed inside a frame hung on the display panel 52, and the coordinate detecting area 521 can be a transparent panel disposed on the frame so as to be installed on the different display panels 52.

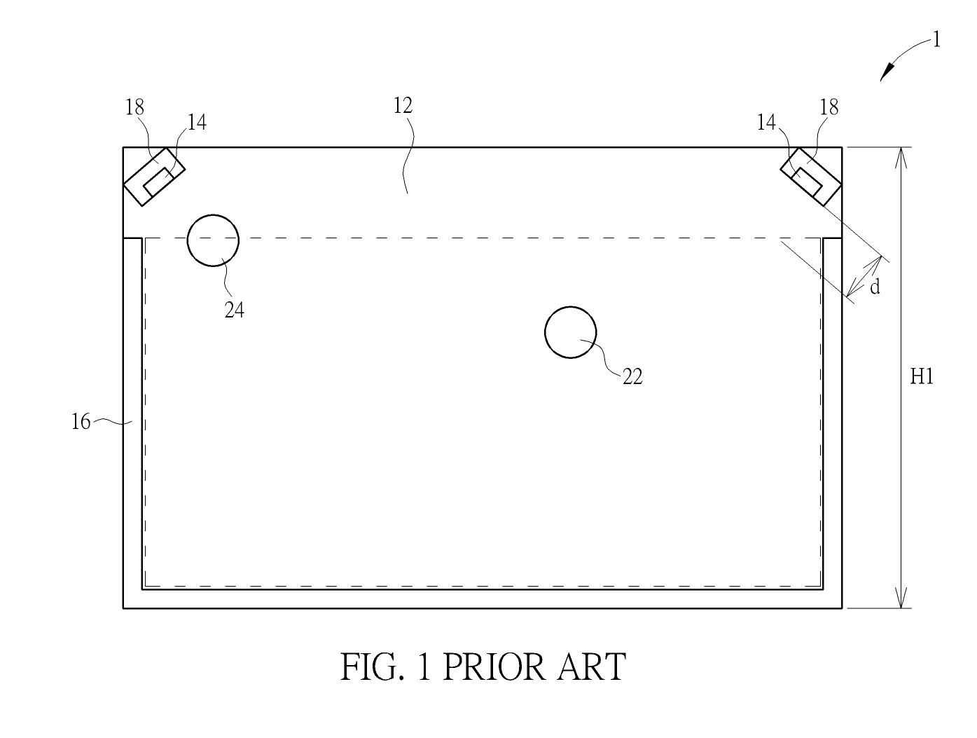

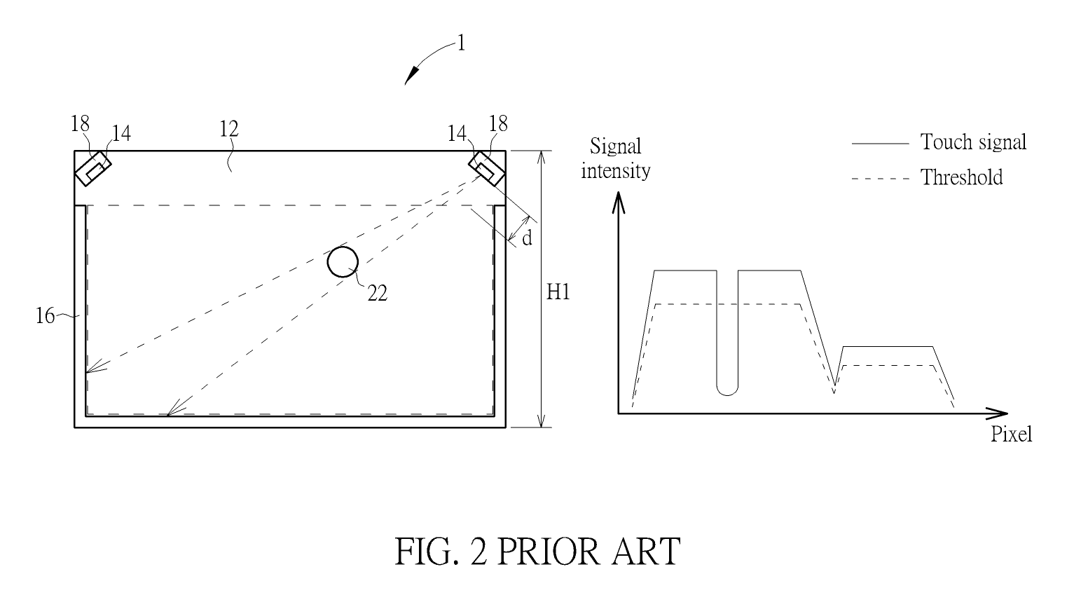

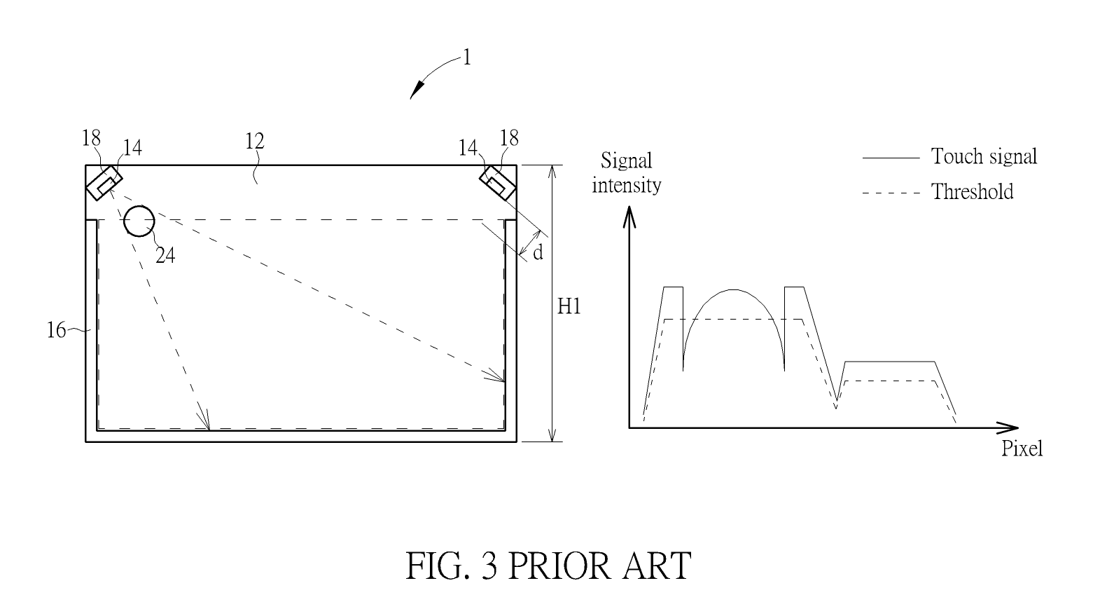

It should be noticed that the two reflective units 52 and two image capturing modules 58 are respectively spaced from each other in the predetermined distance dl in a horizontal direction X, and the predetermined distance dl is greater than or equal to a distance d shown in FIG. 1, so as to prevent image overexposure. Therefore, a height of the optical image system 5 can be less than a height of the conventional optical image system 1 because the reflective units 52 and the image capturing 58 are both disposed along the horizontal direction X of the same outer side of the coordinate detecting area 521. As a result, the dimension of the optical image system 5 can be reduced so as to save mechanical space.

Detailed introduction of operation of the optical image system 5 is described as follows. The two light sources 54 emit collimated light beams to the two reflective units 56, and the two reflective units 56 can further respectively reflect the collimated light beams emitted from the two light sources 54 so that the light can spread all over the coordinate detecting area 521 and the light reflected from the two reflective units 56 can illuminate the touch object 62. Then, the touch object 62 can reflect the light back to the reflective units 56. The two reflective units 56 respectively reflect light reflected from the touch object 62 to the two image capturing modules 58 so that the two image capturing modules 58 respectively capture the light reflected from the two reflective units 56.

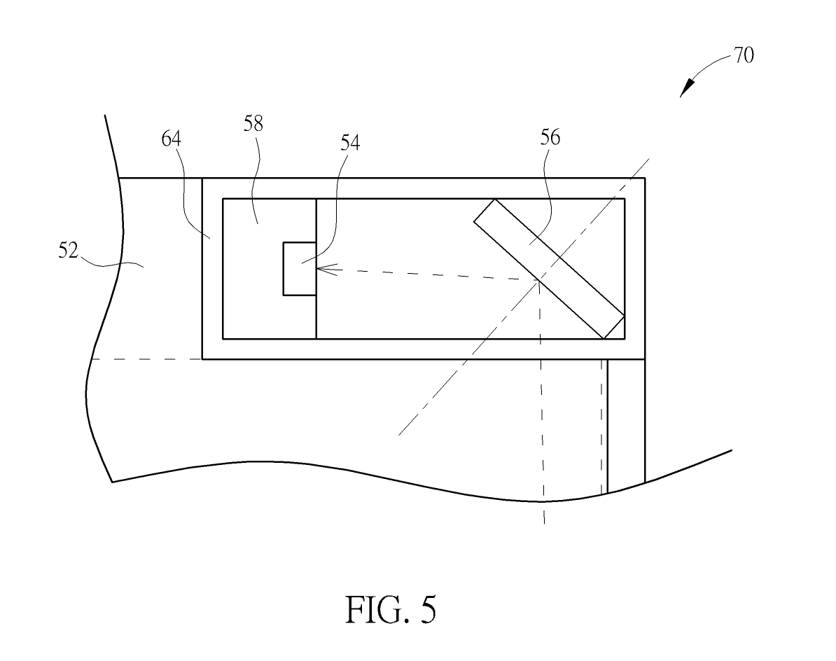

Please refer to FIG. 4 and FIG. 5. FIG. 5 is a structural diagram of the light source 54 and the image capturing module 58 according to the first embodiment of the invention. In this embodiment, the light source 54 can be disposed on the image capturing module 58 so as to save mechanical space and enhance convenience of installation. The optical image system 5 further includes a housing 64. The reflective unit 56 is installed on an end of the housing 64. The light source 54 and the image capturing module 58 are installed on the other end of the housing 64. The housing 64, the light source 54, the reflective unit 56 and the image capturing module 58 can be assembled together inside an optical machine module 70. By means of modularizing the housing 64, the light source 54, the reflective unit 56 and the image capturing module 58, the above components of the optical machine module 70 can be easily and rapidly installed on an area outside the coordinate detecting area 521, and the modular optical machine module 70 is applicable to various display panels 52 with different sizes so as to save the cost of a manufacturing mold.

According to an embodiment, the optical image system 5 can include a reflective frame disposed around an outer side of the display panel 52. The light source 54 emits light to the reflective frame, and the image capturing module 58 can capture the light reflected from the reflective frame so as to generate an initial signal with high intensity. The image capturing module captures the light reflected from the touch object 62 moving within the coordinate detecting area 521 so as to generate an interrupting signal corresponding to the touch object 62. The touch object 62 interrupts a part of the reflective frame so that the signal intensity of the interrupting signal is less than the signal intensity of the initial signal. The control module 60 calculates the coordinate value of the touch object 62 on the coordinate detecting area 521 according to the interrupting signal when the signal intensity of the interrupting signal is less than a threshold. Besides, the present invention is not limited to the above-mentioned embodiment. According to another embodiment, the optical image system 5 can exclude the reflective frame. That is, the light emitted from the light source 54 is not reflected by the reflective frame so that the image capturing module 58 generates an initial signal with low intensity. The image capturing module 58 captures the light reflected from the touch object 62 moving within the coordinate detecting area 521 so as to generate a reflecting signal corresponding to the touch object 62. The signal intensity of the reflecting signal is greater than the signal intensity of the initial signal. The control module calculates the coordinate value of touch object 62 on the coordinate detecting area 521 according to the reflecting signal when the signal intensity of the reflecting signal is greater than another threshold.

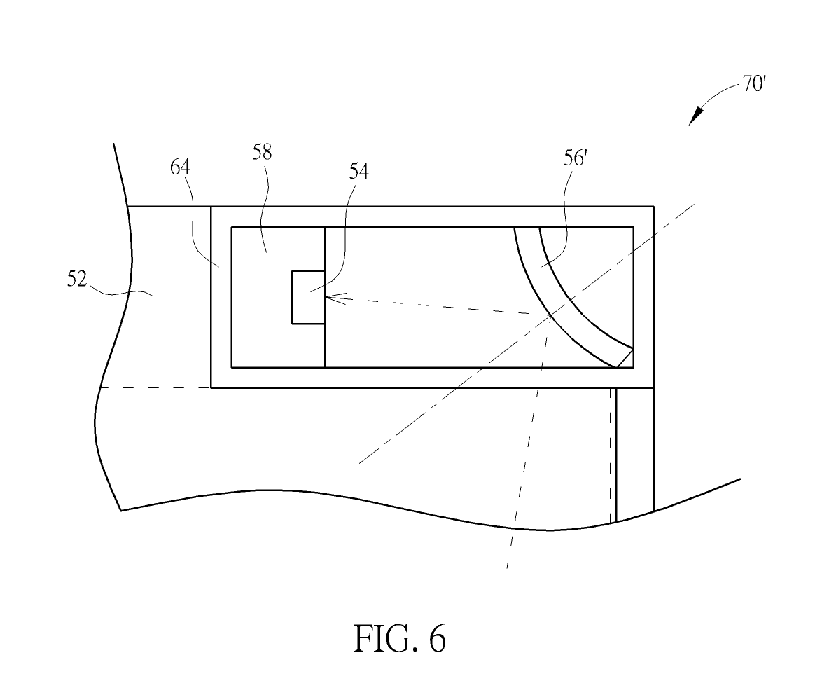

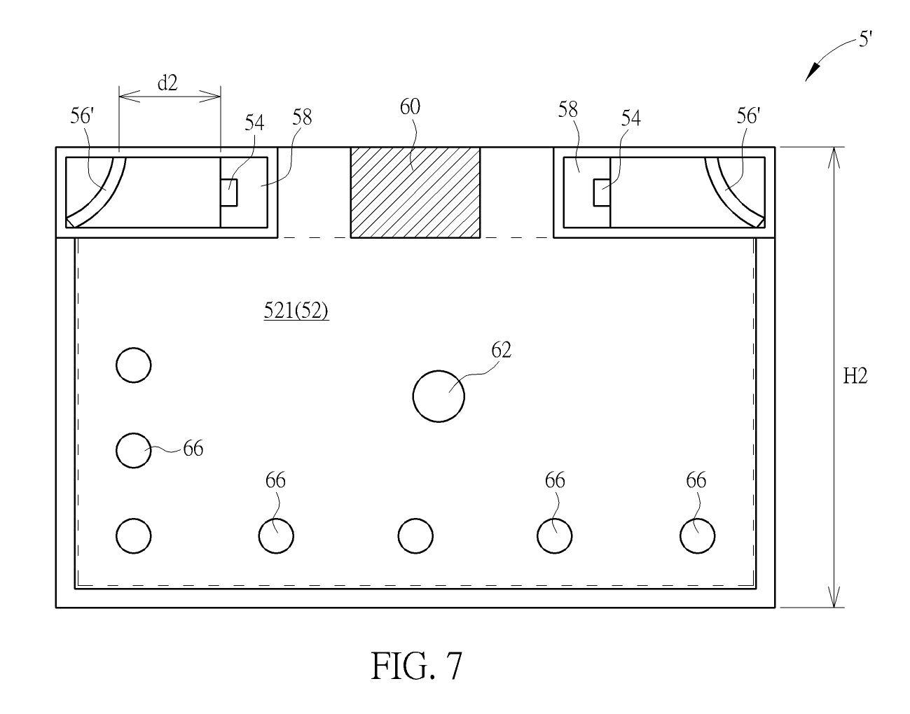

Please refer to FIG. 6 and FIG. 7. FIG. 6 is a schematic diagram of an optical machine module 70′ according to a second embodiment of the invention. FIG. 7 is a schematic diagram of an optical image system 5′ according to the second embodiment of the invention. The difference between the first embodiment and the second embodiment is that a reflective unit 56′ is a convex mirror in the second embodiment. For simplicity, elements that have the same structures and functions as that illustrated in the aforementioned embodiment are provided with the same item numbers in this embodiment . In this embodiment, the image capturing module 58 and the reflective unit 56′ are spaced from each other in a predetermined distance d2. A reflective angle of the reflecting unit 56′, which is a convex mirror, is larger than a reflective angle of the reflective unit 56, which is a planar mirror, so that the reflective light of the reflecting unit 56′ can easily spread all over the coordinate detecting area 521. Therefore, the predetermined distance d2 in this embodiment can be less than the predetermined distance dl in the aforementioned embodiment so that the size of the optical machine module 70′ can be reduced. Besides, a height H2 of the optical image system 5′ in the second embodiment can be less than the height H1 of the optical image system 5 in the first embodiment.

In order to enhance the touch accuracy of the optical image system 5′, the optical image system 5′ can further include a plurality of positioning units 66 as shown in FIG. 7. The plurality of positioning units 66 is disposed around the coordinate detecting area 521, and the positioning unit 66 can be a calibration rod. A plurality of positioning units 66 can be equally spaced around the coordinate detecting area 521 or can be arranged around the coordinate detecting area 521 with equal angles, and it depends on the actual requirement. The reflective units 56′ reflect the light reflected from the plurality of positioning units 66 to the image capturing modules 58, and the control module calculates the coordinate value of the touch object 62 on the coordinate detecting area 521 according to the light reflected from the touch object 62 and the plurality of positioning units 66 and captured by the image capturing modules 58. The image signal of the plurality of positioning units captured by the image capture modules 58 can be a basis of image correction, and parameters corresponding to the positioning units 66 at different locations can be calculated by interpolation. The control module 60 can execute correction calculation according to the parameters and correct the captured distorted image by using the convex mirror, so as to accurately calculate the coordinate value of the touch object 62 on the coordinate detecting area 521.

In contrast to the prior art, the optical image system of the present invention increases an optical path of the reflective light reflected from the touch object in the horizontal direction by means of spaced disposal of the image capturing module and the reflective unit in the horizontal direction so as to prevent image overexposure caused by a close distance between the touch object and the image capturing module, resulting in misjudgment of the location of the touch object on the coordinate detecting area. Besides, the present invention can effectively reduce the dimension of the optical image system and achieve convenient assembly and utilization. Therefore, it fulfills the design trends of slimness and light weight of the modern consumer product. Furthermore, the light source, the reflective unit and the image capturing module can be installed in the same optical machine module so that all components can be rapidly installed on the display module, and the modular optical machine module can be applicable to the various display panels with different sizes so as to save the cost of the manufacturing mold.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical imaging system capable of preventing overexposure, and the optical imaging system comprising:
a display panel, whereon a coordinate detecting area is formed;
at least one light source module disposed on an outer side of the display panel and for emitting light so as to illuminate an touch object within the coordinate detecting area;
at least one reflective unit disposed on an outside corner of the display panel;
at least one image capturing module disposed on an outer side of the display panel and being spaced from the at least one reflective unit in a predetermined distance, the at least one reflective unit reflecting light reflected from the touch object to the at least one image capturing module, the at least one image capturing module capturing the light reflected from the at least reflective unit so as to generate a touch signal corresponding to the touch object; and
a control module coupled to the at least one image capturing module and for calculating a coordinate value of the touch object on the coordinate detecting area of the display panel according to the touch signal.

2. The optical imaging system of claim 1, wherein the at least one light source, the at least one reflective unit and the at least one image capturing module are disposed on an outer side of the coordinate detecting area.

3. The optical imaging system of claim 2, wherein the at least one light source is a laser light emitting diode or an infrared light emitting diode for emitting a collimated light beam, and the at least reflective unit further reflects the collimated light beam emitted from the at least one light source to the touch object.

4. The optical imaging system of claim 2, wherein the at least reflective unit and the at least one image capturing module are spaced from each other in the predetermined distance in a horizontal direction.

5. The optical imaging system of claim 1, comprising two image capturing modules and two reflective units, the two reflective units being respectively disposed on two opposite outside corners of the display panel, incident sides of the two image capturing modules facing away from each other, and the two image capturing modules being disposed between the two reflective units and for capturing the light reflected from the two reflective units.

6. The optical imaging system of claim 1, wherein the at least one image capturing module captures the light reflected from the at least one reflective unit when the touch object moves within the coordinate detecting area so as to generate an interrupting signal corresponding to the touch object, and the control module calculates the coordinate value of the touch object on the coordinate detecting area according to the interrupting signal as a signal intensity of the interrupting signal is less than a threshold.

7. The optical imaging system of claim 1, wherein the at least one image capturing module captures the light reflected from the at least one reflective unit when the touch object moves within the coordinate detecting area so as to generate a reflecting signal corresponding to the touch object, and the control module calculates the coordinate value of the touch object on the coordinate detecting area according to the reflecting signal as a reflecting signal intensity is greater than a threshold.

8. The optical imaging system of claim 1, wherein the at least one reflective unit is a planar mirror or a convex mirror.

9. The optical imaging system of claim 8, further comprising a plurality of positioning units disposed around the coordinate detecting area, the at least one reflective unit reflecting light reflected from the plurality of positioning units to the at least one image capturing module, and the control module further calculating the coordinate value of the touch object on the coordinate detecting area according to the light reflected from the touch object and the plurality of positioning units and captured by the at least one image capturing module.

10. The optical imaging system of claim 9, wherein the plurality of positioning units is equally spaced around the coordinate detecting area.

11. The optical imaging system of claim 1, further comprising a plurality of positioning units disposed around the coordinate detecting area, the at least one reflective unit reflecting the light reflected from the plurality of positioning units to the at least one image capturing module, and the control module further calculating the coordinate value of the touch object on the coordinate detecting area according to the light reflected from the touch object and the plurality of positioning units and captured by the at least one image capturing module.

12. The optical imaging system of claim 11, wherein the plurality of positioning units is equally around the coordinate detecting area.
